(19) United States
(12) Patent Application Publication
(10) Pub. No.: US 2018/0290834 A1
(43) Pub. Date: Oct. 11, 2018

(54) MOTORIZED HEIGHT ADJUSTOR AND CHECKOUT STATION WITH MOTORIZED HEIGHT ADJUSTOR

(71) Applicant: Walmart Apollo, LLC, Bentonville, AR (US)

(72) Inventors: Yurgis Mauro Bacallao, Centerton, AR (US); Douglas Jahe Ryner, Cave Springs, AR (US)

(21) Appl. No.: 15/941,088

(22) Filed: Mar. 30, 2018

Related U.S. Application Data
(60) Provisional application No. 62/483,706, filed on Apr. 10, 2017.

(51) Int. Cl. B65G 21/12; A47F 9/04; F16H 25/20

(52) U.S. Cl. CPC B65G 21/12; A47F 9/04; F16H 25/20; A47F 2009/041; F16H 2025/2084; B65G 2812/02019; B65G 2812/02089; F16H 2025/2046; F16H 2025/204; B65G 2203/0283

(57) ABSTRACT

Described is a checkout station with an adjustable height conveyor belt, and a motorized height adjustor that is used to level and adjust the height of the conveyor belt. The motorized height adjustor includes an adjustable height leg and a motor drive. The motor drive uses a motor to rotate a foot sleeve of the adjustable height leg. Rotating the foot sleeve adjusts the height of the adjustable height leg. Adjusting the height of the adjustable height leg adjusts the height of the conveyor belt of the checkout station. The motorized height adjustor can be coupled to sensors to automatically adjust the height of the conveyor belt.

### CROSS REFERENCE TO RELATED APPLICATION

This invention claims priority to U.S. provisional patent application Ser. No. 62/483,706, filed Apr. 10, 2017, and entitled “Motorized Height Adjustor and Checkout Station with Adjustable Height Conveyor Belt”, which is incorporated entirely herein by reference.

### BACKGROUND OF THE INVENTION

### Technical Field

This invention relates to an adjustable height leg for adjusting the height of a table or surface, and specifically to a checkout station with a conveyor belt that uses a motorized height adjustor that includes an adjustable height leg to adjust the height of the conveyor belt.

### State of the Art

A customer of a retail store brings items to a checkout station of the retail store to have their items rung up and bagged. Checkout stations often include a checkout register on a stand, and a conveyor belt that conveys items to the checkout register. An issue arises for the retail store when the conveyor belt has a different height than the checkout register. If the conveyor belt is at a different height than the checkout register stand, items can fall off of the conveyor belt, or break, at the transition from the conveyor belt to the checkout register. The checkout register and stand are often obtained from a different source than the conveyor belt and stand, and so they sometimes have different heights.

Accordingly, what is needed is an adjustable height leg that can adjust the height of a retail store conveyor belt until it is the same height as the checkout register stand. Also, what is needed is a conveyor belt for a checkout station with an automatic level sensor that can level and adjust the height of the conveyor belt automatically.

### BRIEF DESCRIPTION OF THE DRAWINGS

FIG. 1 shows a front view of a checkout station for a retail store;

FIG. 2 shows a rear view of a cabinet for a conveyor belt, showing a motorized height adjustor and an adjustable height leg that supports the conveyor belt;

FIG. 3 shows a front view of an adjustable height leg;

FIG. 4 shows a perspective view of a motor drive for a motorized height adjustor;

FIG. 5 shows an exploded view of an adjustable height leg and worm gear;

FIG. 6 shows a cross section of an adjustable height leg; and

FIG. 7 illustrates a method of adjusting a conveyor belt height of a checkout station.

### DETAILED DESCRIPTION OF EMBODIMENTS OF THE INVENTION

As discussed above, embodiments of the present invention relate to an adjustable height leg for adjusting the height of a table or surface, and, specifically, to a checkout station with a conveyor belt that uses a motorized height adjustor with an adjustable height leg to adjust the height of the conveyor belt.

Disclosed is a checkout station in a retail store that includes a conveyor belt. The conveyor belt conveys items to be purchased to a checkout register. The conveyor belt has at least one motorized height adjustor that provides a means to adjust the height of the conveyor belt. The motorized height adjustor includes an adjustable height leg and a motor drive. The motor drive includes a motor that drives the adjustable height leg. The adjustable height leg is used to adjust the height of the conveyor belt and to level the conveyor belt. There can be instances where the conveyor belt has a different height than the checkout register that receives items. This can be a problem because items to be purchased are conveyed from the conveyor belt to the checkout register stand. If the conveyor belt and the checkout register stand are at different heights, items may fall and break or get caught at the transition point. It is desirable to be able to adjust the height of the conveyor belt so that it matches the height of the checkout register stand. The disclosed checkout station includes an adjustable height leg that both levels and adjusts the height of the conveyor belt so it matches the height of the checkout register stand. In some embodiments, the conveyor belt includes level sensors that sense whether the conveyor belt is level or not, and automatically adjust the adjustable height leg until the conveyor belt is level.

Disclosed is an adjustable height leg that can be used to adjust the height of tables or surfaces. The adjustable height leg described herein is used to adjust the height of a conveyor belt at a checkout station, but this is an example only and not meant to be limiting. The adjustable height leg can be used to adjust the height of many different types of surfaces or devices, such as tables, beds, hospital beds and hospital operating tables, racks and bins in retail stores, or any other support structure or device that can benefit from having an adjustable height leg. The adjustable height leg is driven by a motor drive. The motor drive causes a height of the adjustable height leg to be adjusted. In some embodiments, the motor drive is controlled by level or height sensors that automatically sense the status of the table or surface held up by the adjustable height leg, and adjusts the height of the adjustable height leg accordingly.

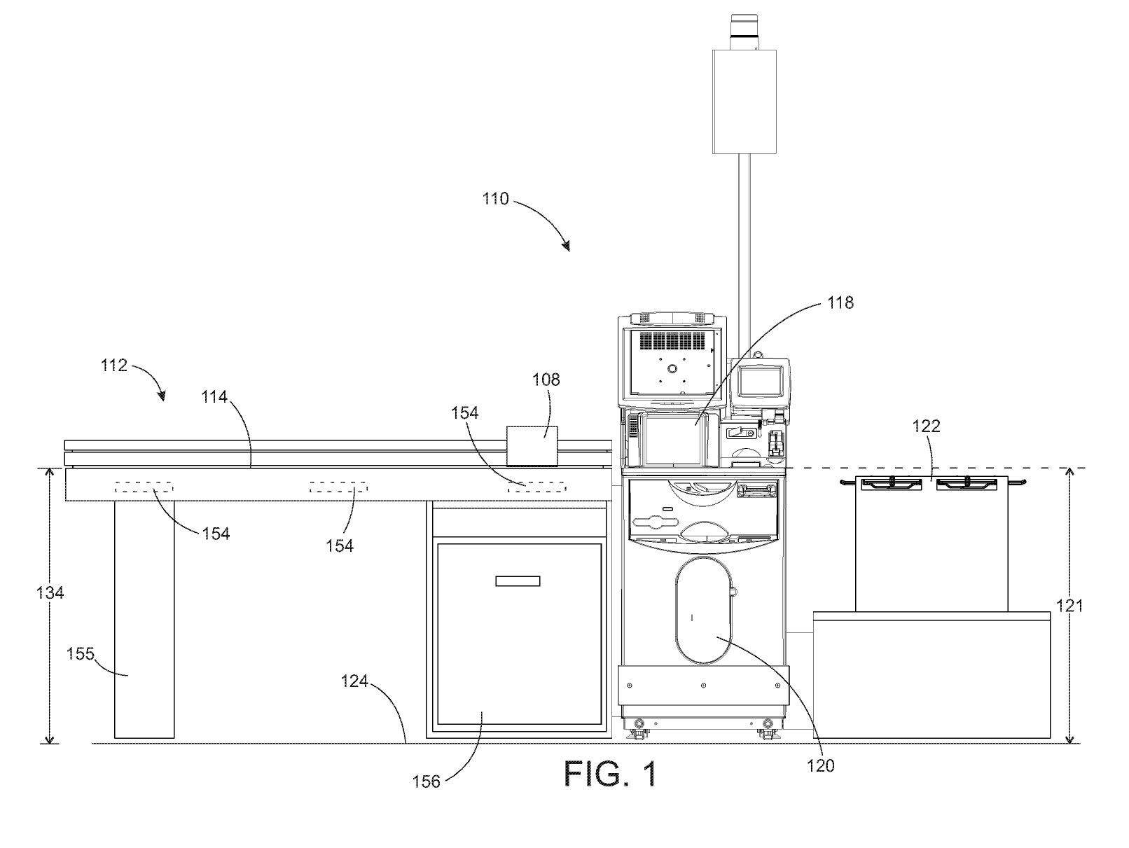

FIG. 1 shows a front view of a checkout station 110 in a retail store. Checkout station 112 includes a conveyor belt system 112, a checkout register 118 on a checkout register stand 120, and a bagging station 122. A customer brings one or more items to be purchased, such as item 108 shown in FIG. 1, to checkout station 110. Item 108 is conveyed on a conveyor belt 114 of conveyor belt system 112 to register stand 120, where item 108 is scanned or “rung up” into register 118. Once the customer pays for item 108, it is bagged at bagging station 122 before the customer removes item 108 from the retail store.

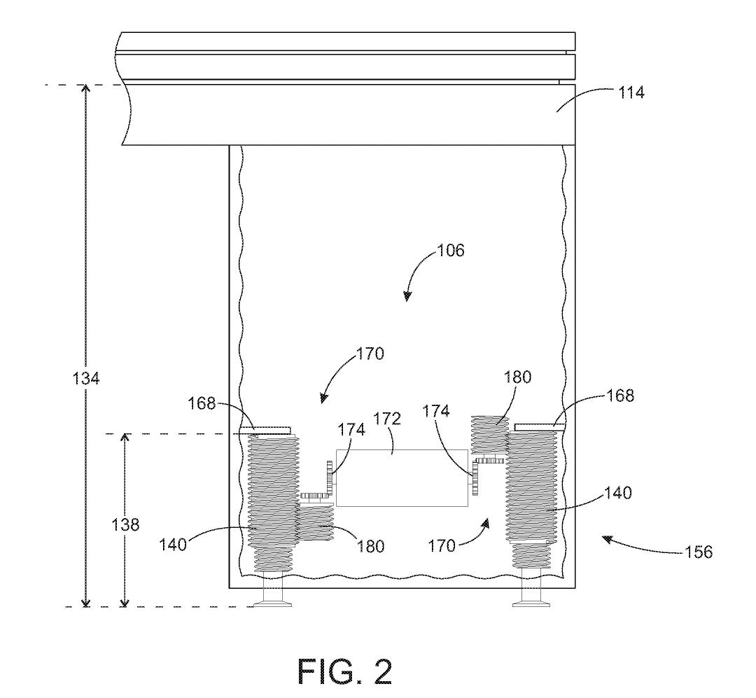

Checkout station 110 includes at least one motorized height adjustor 106, as shown in FIG. 2. Each motorized height adjustor 106 includes at least one adjustable height leg 140, as shown in FIG. 2. Adjustable height leg 140 is used to both level and adjust the height of conveyor belt 114.

Conveyor belt system 112 includes conveyor belt 114, an outer support 155, and a drawer cabinet 156, as shown in FIG. 1. FIG. 2 shows a rear view of drawer cabinet 156, with a rear side of drawer cabinet 156 cut away so that it can be seen how conveyor belt 114 is supported by a motorized height adjustor 106. Motorized height adjustor 106, in this embodiment, includes two adjustable height legs 140. Motorized height adjustor 106 also includes at least one motor drive 170. Adjustable height legs 140 are used to both level conveyor belt 114, and to adjust a conveyor belt height 134. Adjustable height legs 140 can be used to adjust conveyor belt height 134 to match a register stand height 121 (FIG. 1). If register stand height 121 and conveyor belt height 134 do not match, the operation of checkout station 110 is compromised and item 108 could be mis-handled or damaged. Using one or more adjustable height leg 140 to support conveyor belt 114 provides a means to match conveyor belt height 134 to register stand height 121.

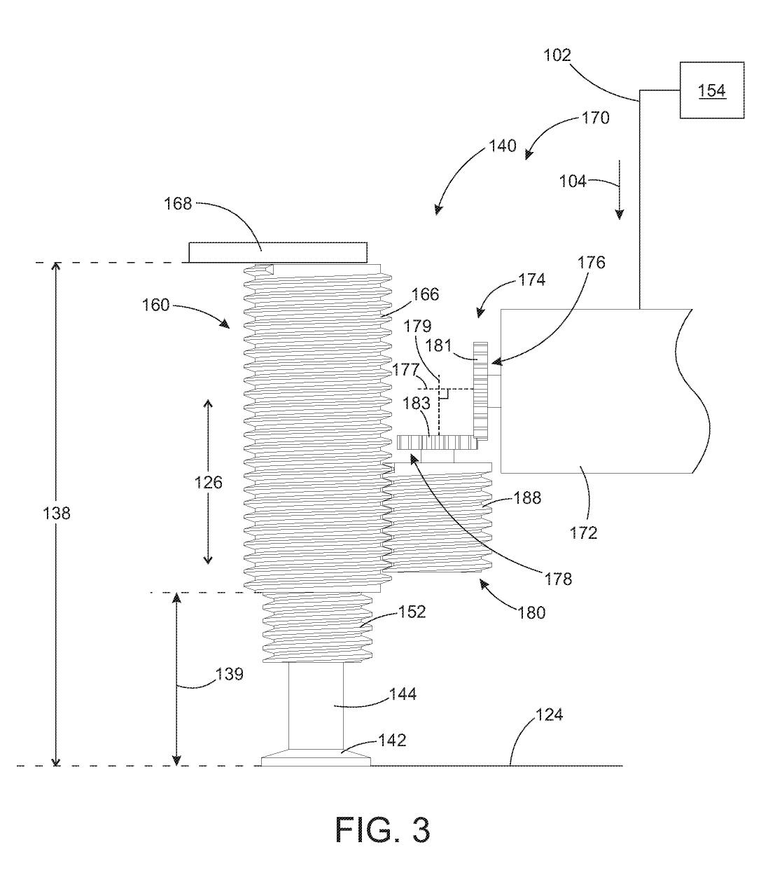

In the embodiment shown in FIG. 1, checkout station 110 also includes three level sensors 154. Level sensors 154 are communicatively coupled to motorized height adjustor 106 (see FIG. 3) such that adjustable height legs 140 can be used to level conveyor belt 114, as described herein.

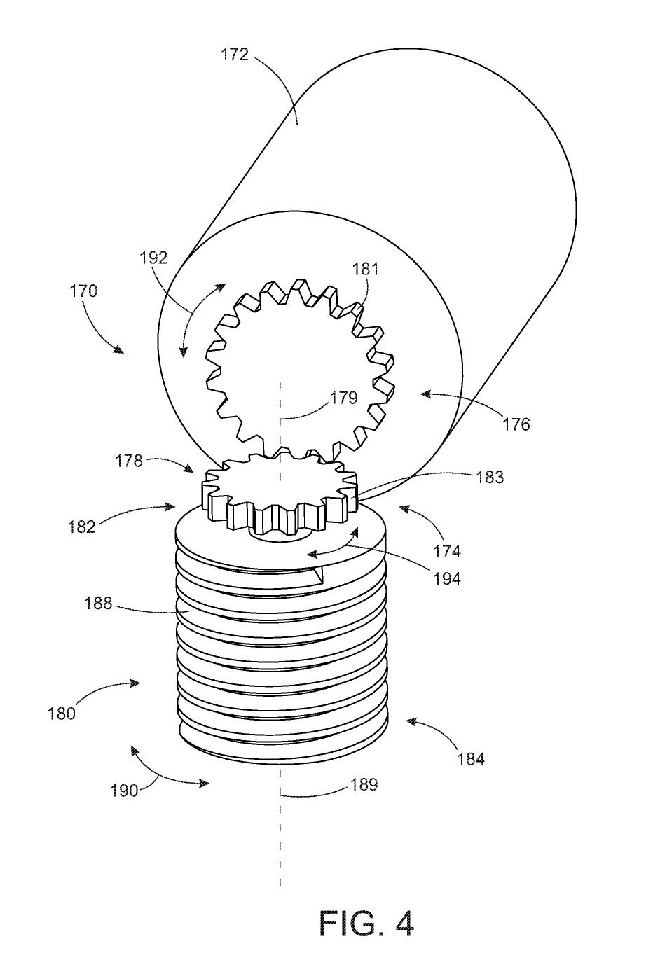

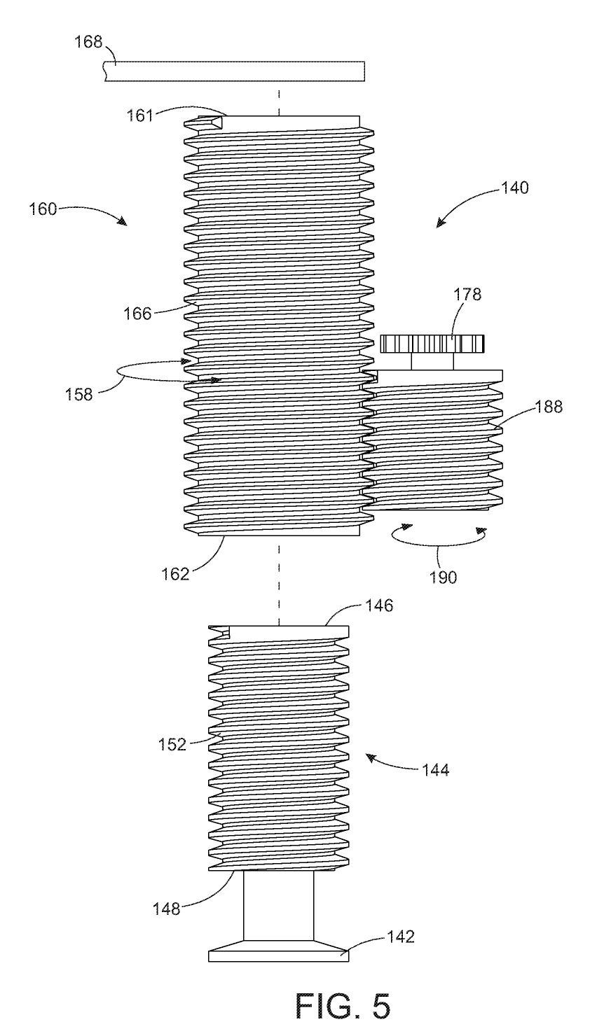

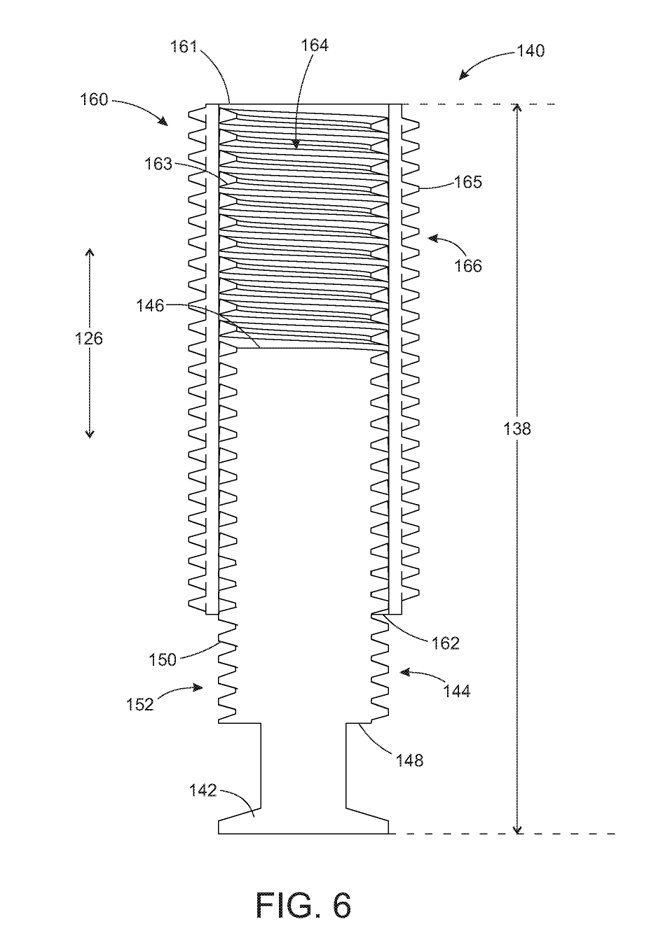

FIG. 2 through FIG. 6 show details of motorized height adjustor 106. Motorized height adjustor 106 includes at least one motor drive 170 and at least one adjustable height leg 140. FIG. 2 shows a rear view of cutaway drawer cabinet 156 showing motorized height adjustor 106 coupled to foot sleeve coupler 168 and drawer cabinet 156. FIG. 3 shows a simplified diagram of a portion of motorized height adjustor 106 of FIG. 2 mechanically coupled to foot sleeve coupler 168 of drawer cabinet 156 and communicatively coupled to level sensor 154. FIG. 4 shows a perspective view of a motor drive 170 of motorized height adjustor 106. FIG. 5 shows an exploded view of an adjustable height leg 140. FIG. 6 shows a cross section view of adjustable height leg 140.

Checkout station 110 includes a motorized height adjustor 106 located in outer support 155 (the motorized height adjustor 106 in support 155 is not shown), and a motorized height adjustor 106 in drawer cabinet 156, as shown in FIG. 2. Checkout station 110 can include any number of motorized height adjustors 106 and adjustable height legs 140 as needed to both support and adjust the height of conveyor belt 114. Conveyor belt systems for checkout stations come in different lengths and configurations, and can use different numbers and configurations of motorized height adjustors 106 and adjustable height legs 140 as needed to level and adjust the height of the conveyor belt.

Checkout station 110 includes a motorized height adjustor 106 in drawer cabinet 156, as shown in FIG. 2. Motorized height adjustor 106 includes two motor drives 170, which each share a motor 172, and two adjustable height legs 140. Each adjustable height leg 140 is coupled to drawer cabinet 156 using a foot sleeve coupler 168. Foot sleeve coupler 168 couples adjustable height leg 140 to drawer cabinet 156 such that adjusting an adjustable height leg height 138 of adjustable height leg 140 (FIG. 2, FIG. 3, and FIG. 6), adjusts conveyor belt height 134, as shown in FIG. 2. Foot sleeve coupler 168 is an elongate member such as a bar, rod, or plate that mechanically couples adjustable height leg 140 to drawer cabinet 156. Adjustable height leg height 138 is the distance between foot sleeve coupler 168 and support surface 124.

FIG. 3 shows a portion of motorized height adjustor 106, including one adjustable height leg 140 and one motor drive 170. Motorized height adjustor 106 includes, in this embodiment, one motor 172, two motor drives 170 (both shown in FIG. 2, one shown in FIG. 3), and two adjustable height legs 140 (both shown in FIG. 2, one shown in FIG. 3). Motor 170 causes the adjustment of adjustable height leg height 138 of adjustable height leg 140, which in turn adjusts conveyor belt height 134 (FIG. 1 and FIG. 2). In this embodiment, motor 170 is communicatively coupled to one or more level sensors 154 using communication 102. In this embodiment, communication 102 can include, among other communications, a motor rotation instruction 104, which causes motor 172 to adjust adjustable height leg height 138 of adjustable height leg 140.

Adjustable height leg 140 is driven by motor drive 170, as shown in FIG. 3. FIG. 4 shows a perspective view of motor drive 170. Motor drive 170 includes a face gear 174 coupled to motor 172. Motor 172 rotates face gear 174 in rotations 192 and 194. Motor drive 170 also includes a worm gear 180 coupled to face gear 174. A rotation 192 and 194 of face gear 174 causes a worm gear rotation 190. Worm gear 180 is coupled to adjustable height leg 140 such that worm gear rotation 190 causes height 138 of adjustable height leg 140 to be adjusted, as explained in detail herein.

A face gear is a combination of two gears that have their gears mechanically meshed, or engaged, such that the rotation of one of the two gears causes a rotation of the other of the two gears. In this embodiment, face gear 174 includes a drive spur gear 176 and a driven spur gear 178, as shown in the figures. Drive spur gear 176 has a drive spur gear rotation axis 177 and a set of drive spur gear teeth 183, as shown in FIG. 3 and FIG. 4. Driven spur gear 178 has a driven spur gear rotation axis 179 and a set of driven spur gear teeth 183. Set of drive spur gear teeth 181 mechanically engage, or mesh with, set of driven spur gear teeth 183, which couples drive spur gear 176 to driven spur gear 178. Drive spur gear 176 and driven spur gear 178 are coupled perpendicular to one another in this embodiment, and are approximately the same size, but this is not meant to be limiting. Drive spur gear 176 and driven spur gear 178 being coupled perpendicular to one another means drive spur gear rotation axis 177 and driven spur gear rotation axis 179 are perpendicular to one another, see FIG. 3. Set of drive spur gear teeth 181 mechanically engage, or mesh with, set of driven spur gear teeth 183, such that when drive spur gear 176 undergoes a rotation 192, driven spur gear 178 undergoes a rotation 194, as shown in FIG. 4. Drive spur gear 176 is fixedly coupled to motor 172. Motor 172 rotates drive spur gear 176 in rotation 192.

Driven spur gear 178 is fixedly coupled to worm gear 180, as shown in FIG. 4. A worm gear is a rod with a threaded outer surface, where the threads are used to engagedly couple with (drive or be driven by) another gear. In this embodiment, worm gear 180 is a cylinder with a worm gear top end 182 and a worm gear bottom end 184. Worm gear 180 has a rotation axis 190. Worm gear 180 has a set of worm gear threads 188 on an outer surface of worm gear 180. Driven spur gear 178 is fixedly coupled to worm gear 180 such that rotation 194 of driven spur gear 178 rotates worm gear 180 in a worm gear rotation 190, and vice versa. Driven spur gear 178 has driven spur gear axis of rotation 179, as shown in FIG. 4. Driven spur gear 178 is fixedly coupled to worm gear 180 such that driven spur gear axis of rotation 179 is collinear with a worm gear axis of rotation 189, as shown in FIG. 4. Motor 172 rotates drive spur gear 176 in drive spur gear rotation 192, which rotates driven spur gear 178 in driven spur gear rotation 194. Driven spur gear rotation 194 rotates worm gear 180 in worm gear rotation 190. Thus, motor 172 rotates face gear 174 in rotation 192 and 194, which rotates worm gear 180 in rotation 190. The diameter of driven spur gear 178 is less than the diameter of worm gear 180, so that driven spur gear 178 does not interfere with the mechanical engagement of worm gear 180 to adjustable height leg 140.

Adjustable height leg 140 supports conveyor belt 114. Adjustable height leg 140 raises and lowers conveyor belt 114, adjusting belt height 134, as shown in FIG. 1. Adjustable height leg 140 is best seen in FIG. 2, FIG. 3, FIG. 5, and FIG. 6. FIG. 2 shows how motorized height adjustor 106, including two adjustable height legs 140, are enclosed in drawer cabinet 156 in this embodiment. Conveyor belt system 112 can include more adjustable height legs 140, such as in outer support 155, for example, but not by way of limitation. Conveyor belt system 112 can include as many motorized height adjustors 106 and adjustable height legs 140 as needed to level and adjust the height of conveyor belt 114.

Adjustable height leg 140 is coupled to drawer cabinet 156 using foot sleeve coupler 168, as can be seen in FIG. 2 and FIG. 3. FIG. 2 shows a simplified rear cutaway view of drawer cabinet 156, showing how motorized coupler 106 is coupled to drawer cabinet 156 using foot sleeve coupler 168. FIG. 3 shows a simplified side view of one adjustable height let 140 of motorized height adjustor 106. FIG. 5 shows an exploded view of adjustable height leg 140. FIG. 6 shows a cross-sectional view of adjustable height leg 140.

Adjustable height leg 140 includes a foot pad 142. Foot pad 142 sets on a support surface 124, which in this embodiment is the floor that checkout station 110 rests on. Foot pad 142 is the foot which supports conveyor belt system 112. Foot pad 142 is fixedly coupled to a foot shaft 144. Foot shaft 144 is an elongate member with a foot shaft top end 146 and a foot shaft bottom end 148, as shown in FIG. 5. Foot shaft bottom end 148 is coupled to foot pad 142. Foot shaft 144 has a set of foot shaft threads 152 on an outer surface of foot shaft 144. Foot shaft 144 extends from foot pad 142 in a direction approximately perpendicular to support surface 124, but this is not meant to be limiting.

Adjustable height leg 140 also includes a foot sleeve 160, as shown in FIG. 3, FIG. 5, and FIG. 6. Foot sleeve 160 is a hollow cylinder with a set of foot sleeve inner threads 164 on a foot sleeve inner surface 163, and a set of foot sleeve outer threads 166 on a foot sleeve outer surface 165, as can best be seen in FIG. 6. Foot sleeve 160 is threadably and rotatably coupled to foot shaft 144. Threadably coupled means mechanically engaged by threads. Foot sleeve 160 is threadably coupled to foot shaft 144 by threading foot sleeve 160 onto foot shaft 144. Foot sleeve inner threads 164 are threaded onto foot shaft threads 152 to thread foot sleeve 160 onto foot shaft 144, see FIG. 5 and FIG. 6. A foot sleeve rotation 158, which can be in either direction, raises or lowers foot sleeve 160 in direction 126 (FIG. 3 and FIG. 6) on foot shaft 144. Foot sleeve 160 is mechanically coupled to drawer cabinet 156 through foot sleeve coupler 168. Rotation 158 of foot sleeve 160 increases or decreases height 138 of adjustable height leg 140, as shown in FIG. 6. Adjusting height 138 of adjustable height leg 140 adjusts conveyor belt height 134, as shown in FIG. 1. This is how adjustable height leg 140 adjusts the height and/or levels conveyor belt 114. Foot sleeve rotation 158 moves foot sleeve 160 up or down on foot shaft 144, which raises or lowers foot sleeve coupler 168 and conveyor belt 114. Foot sleeve rotation 158 also adjusts a distance 139 between foot sleeve 160 and foot pad 142, as shown in FIG. 3. Distance 139 is increased or decreased in response to a foot sleeve rotation 158. Whether distance 139 is increased or decreased depends on the direction of rotation 158.

Adjustable height leg 140 is coupled to motor drive 170, as shown in FIG. 2 and FIG. 3. FIG. 4 shows a simplified perspective view of motor drive 170. Worm drive threads 188 engagedly mesh, or couple, to foot sleeve outer threads 166 to couple motor drive 170 to adjustable height leg 140.

Motor drive 170 is used to rotate foot sleeve 160 to raise and lower conveyor belt 114 (adjust conveyor belt height 134). Motor drive 170 is coupled to foot sleeve 160, and causes foot sleeve rotation 158, which raises and lowers conveyor belt 114.

Motor drive 170 includes motor 172, face gear 174, and worm gear 180, as shown in FIG. 2, FIG. 3and FIG. 4 and explained above. In the embodiment shown, motor drive 170 includes two face gears 174, one at each end of motor 172, and two worm gears 180. Each worm gear 180 is threadably coupled to an adjustable height leg 140. Motor 172 rotates face gear 174. Specifically, motor 172 causes face gear rotation 192 and 194, as shown in FIG. 4. Specifically, motor 172 rotates drive spur gear 176 in rotation 192. Drive spur gear 176 is fixedly coupled to motor 172. Drive spur gear rotation 192 rotates driven spur gear 174 in rotation 194. Drive spur gear rotation 192 rotates driven spur gear 194 in rotation 194 because set of drive spur gear teth 181 mesh with set of driven spur gear teeth 183, see FIG. 3 and FIG. 4. Rotation 194 of driven spur gear 178 rotates worm gear 180 in rotation 190 (FIG. 4 and FIG. 5).

Worm gear 180 is coupled to adjustable height leg 140. Worm gear 180 is threadably coupled to foot sleeve 160. Specifically, worm gear threads 188 mechanically engage foot sleeve outer threads 166 such that worm gear rotation 190 causes foot sleeve rotation 158, see FIG. 3 and FIG. 5. Thus, motor 172 causes face gear rotation 192 and 194, which causes worm gear rotation 190, which causes foot sleeve rotation 158. Foot sleeve rotation 158 causes foot sleeve 160 to raise and lower, depending on the direction of rotations, which causes adjustable height leg 140 to adjust the height of conveyor belt 114. Thus, motor 172 causes adjustable height leg 140 to adjust foot sleeve height 138 and conveyor belt height 134.

Motor 172 is able to adjust the height of conveyor belt 114 by rotating face gear 174. Motor 172 can cause rotation 192 and 194 of face gear 174 in either direction, so motor 172 can cause conveyor belt 114 to raise or lower. In this embodiment, motor 172 is electrically coupled to at least one level sensor 154. Level sensors 154 can be used to automatically sense a level condition of conveyor belt 114, and control motorized height adjustor 106 until conveyor belt height 134 is the same as register stand height 121, and/or conveyor belt 114 is level. If conveyor belt height 134 needs to be adjusted, or conveyor belt 114 is not level, motor 172 will send motor rotation instruction 104 to motor 172, which will raise or lower one or more adjustable height legs 140 until conveyor belt 114 is level and at the same height as register stand 120. When conveyor belt 114 is level and at the same height as register stand 120, item 108 will travel smoothly along conveyor belt 114 and will transfer easily to register stand 120 to be rung up at register 118.

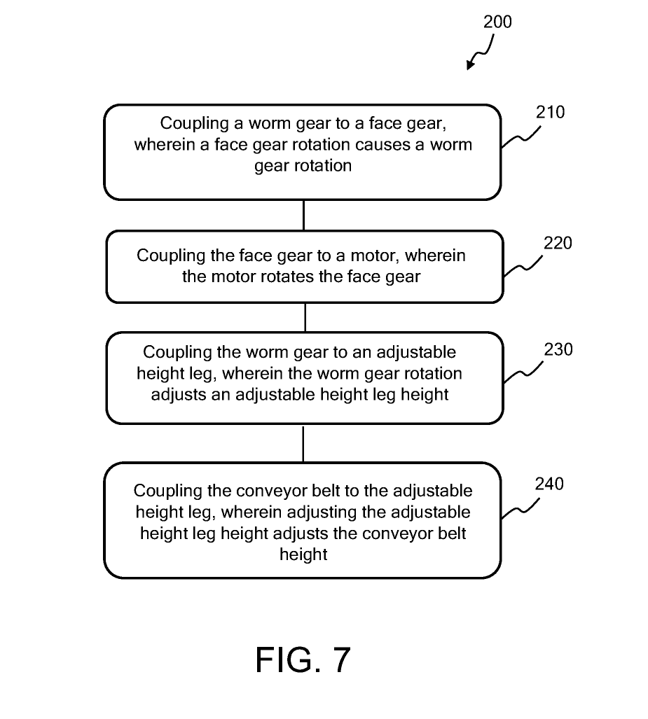

FIG. 7 illustrates a method 200 of adjusting a conveyor belt height of a conveyor belt. Method 200 includes an act 210 of coupling a worm gear to a face gear. A face gear rotation of the face gear causes a worm gear rotation of the worm gear. In some embodiments, the face gear includes a drive spur gear coupled to a driven spur gear, where a drive spur gear rotation causes a driven spur gear rotation. In some embodiments, coupling the worm gear to the face gear includes fixedly coupling the worm gear to the driven spur gear of the face gear, wherein a worm gear axis of rotation of the worm gear and a driven gear axis of rotation of the driven gear are collinear.

Method 200 also includes an act 220 of coupling the face gear to a motor, where the motor rotates the face gear. In some embodiments, coupling the face gear to the motor includes fixedly coupling a drive gear of the face gear to the motor.

Method 200 also includes an act 230 of coupling the worm gear to an adjustable height leg, where the worm gear rotation adjusts an adjustable height leg height. In some embodiments, act 230 of coupling the worm gear to an adjustable height leg includes threadably engaging a set of worm gear threads of the worm gear to a set of foot sleeve outer threads of a foot sleeve, and wherein the worm gear rotation causes a foot sleeve rotation of the foot sleeve.

Method 200 also includes an act 240 of coupling the conveyor belt to the adjustable height leg. Adjusting the adjustable height leg height adjusts the conveyor belt height. In some embodiments, act 240 of coupling the conveyor belt to the adjustable height leg includes coupling a conveyor belt cabinet to a foot sleeve, where the foot sleeve includes a hollow cylinder with a set of foot sleeve inner threads on a foot sleeve inner surface of the foot sleeve, and a set of foot sleeve outer threads on a foot sleeve outer surface. In some embodiments, act 240 of coupling the conveyor belt to the adjustable height leg includes threading the set of foot sleeve inner threads onto a set of foot shaft threads on a foot shaft outer surface of a foot shaft.

In some embodiments, act 240 of coupling the conveyor belt to the adjustable height leg includes fixedly coupling the foot shaft to a foot pad, wherein the foot pad rests on a support surface. A foot sleeve rotation adjusts the adjustable height leg height.

Method 200 can include many other acts. In some embodiments, method 200 includes coupling the motor to a level sensor, where the level sensor controls the motor. In some embodiments, method 200 includes instructing, by the level sensor, the motor to rotate the face gear, in response to the level sensor determining that the conveyor belt is not level. The motor and level sensors can work together to operate the adjustable height leg and raise and lower the conveyor belt until the conveyor belt is level and at a desired height.

It has been shown and described how a motorized height adjustor can be used to both level and change the height of a conveyor belt at a checkout station in a retail store. The motorized height adjustor can be used to adjust the height of any table, surface, or device that rests on legs on a surface. The motorized height adjustor includes an adjustable height leg and a motor drive. The motor drive rotates a foot sleeve of the adjustable height leg, which adjusts the height of the adjustable height leg. Adjusting the height of the adjustable height leg adjusts the height of the table or surface the adjustable height leg is coupled to. In this embodiment, adjusting the height of the adjustable height leg adjusts the height of the conveyor belt of the checkout station.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A checkout station in a retail store, the checkout station comprising:
a conveyor belt;
an adjustable height leg that supports the conveyor belt, wherein the adjustable height leg comprises:
a foot pad that sets on a support surface;
a foot shaft fixedly coupled to the foot pad, wherein the foot shaft has a set of foot shaft threads on a foot shaft outer surface; and
a foot sleeve threadably and rotatably coupled to the foot shaft, wherein an adjustable height leg height is adjusted in response to a foot sleeve rotation; and
a motor drive coupled to the foot sleeve, wherein the motor drive causes the foot sleeve rotation,
wherein the adjustable height leg raises and lowers the conveyor belt in response to the foot sleeve rotation, and wherein the motor drive comprises:
a motor coupled to a face gear, wherein the motor causes a face gear rotation; and
a worm gear fixedly coupled to the face gear, wherein the face gear rotation causes a worm gear rotation; and wherein the worm gear rotation causes the foot sleeve rotation.

2. The checkout station of claim 1, wherein the face gear comprises:
a drive spur gear having a drive spur gear rotation axis and a set of drive spur gear teeth; and
a driven spur gear having a driven spur gear rotation axis and a set of driven spur gear teeth;
wherein the set of drive spur gear teeth mechanically engage the set of driven spur gear teeth, and wherein the drive spur gear rotation axis and the driven spur gear rotation axis are perpendicular to each other.

3. The checkout station of claim 2, wherein the driven spur gear of the face gear is fixedly coupled to the worm gear, and wherein a driven spur gear rotation causes the worm gear rotation.

4. The checkout station of claim 3, wherein the driven spur gear rotation axis and a worm gear rotation axis are collinear.

5. The checkout station of claim 4, wherein the drive spur gear of the face gear is fixedly coupled to the motor, and wherein the motor rotates the drive spur gear to cause the face gear rotation.

6. The checkout station of claim 4, wherein the foot sleeve is a hollow cylinder having a set of foot sleeve inner threads and a set of foot sleeve outer threads. The checkout station of claim 6, wherein a set of worm gear threads of the worm gear engage the set of foot sleeve outer threads of the foot sleeve.

8. The checkout station of claim 1, wherein the foot shaft extends from the foot pad in a direction perpendicular to the support surface.

9. A motorized height adjustor comprising:
an adjustable height leg comprising:
a foot pad that sets on a support surface;
a foot shaft fixedly coupled to the foot pad and extending from the foot pad in a direction perpendicular to the support surface, wherein the foot shaft has a set of foot shaft threads on a foot shaft outer surface; and
a foot sleeve threadably coupled to the foot shaft, wherein the foot sleeve is a hollow cylinder with a set of foot sleeve inner threads and a set of foot sleeve outer threads, and wherein a distance between the foot sleeve and the foot pad is increased or decreased in response to a foot sleeve rotation;
a worm gear coupled to the foot sleeve, wherein a worm gear rotation causes the foot sleeve rotation;
a face gear coupled to the worm gear, wherein a face gear rotation causes the worm gear rotation; and
a motor coupled to the face gear, wherein the motor causes the face gear rotation.

10. The motorized height adjustor of claim 9, wherein the face gear is a perpendicular face gear.

11. The motorized height adjustor of claim 9, wherein the face gear comprises:
a drive spur gear having a drive spur gear rotation axis and a set of drive spur gear teeth; and
a driven spur gear having a driven spur gear rotation axis and a set of driven spur gear teeth;
wherein the set of drive spur gear teeth mechanically engage the set of driven spur gear teeth, and wherein the drive spur gear rotation axis and the driven spur gear rotation axis are perpendicular to each other.

12. The motorized height adjustor of claim 11, wherein the driven spur gear and the worm gear are collinear.

13. The motorized height adjustor of claim 12, wherein the driven spur gear rotation axis and a worm gear rotation axis are collinear.

14. A method of adjusting a conveyor belt height of a conveyor belt, the method comprising:
coupling a worm gear to a face gear, wherein a face gear rotation causes a worm gear rotation;
coupling the face gear to a motor, wherein the motor rotates the face gear;
engagedly coupling the worm gear to an adjustable height leg, wherein the worm gear rotation adjusts an adjustable height leg height; and
coupling the conveyor belt to the adjustable height leg, wherein adjusting the adjustable height leg height adjusts the conveyor belt height.

15. The method of claim 14, wherein the coupling the conveyor belt to the adjustable height leg comprises:
coupling a conveyor belt cabinet to a foot sleeve, wherein the foot sleeve comprises a hollow cylinder with a set of foot sleeve inner threads on a foot sleeve inner surface of the foot sleeve, and a set of foot sleeve outer threads on a foot sleeve outer surface;
threading the set of foot sleeve inner threads onto a set of foot shaft threads on a foot shaft outer surface of a foot shaft; and
fixedly coupling the foot shaft to a foot pad, wherein the foot pad rests on a support surface;
wherein a foot sleeve rotation adjusts the adjustable height leg height.

16. The method of claim 15, wherein the engagedly coupling the worm gear to an adjustable height leg comprises threadably engaging a set of worm gear threads of the worm gear to the set of foot sleeve outer threads, and wherein the worm gear rotation causes the foot sleeve rotation.

17. The method of claim 16, wherein the coupling the worm gear to the face gear comprises fixedly coupling the worm gear to a driven spur gear of the face gear, wherein a worm gear axis of rotation of the worm gear and a driven spur gear axis of rotation of the driven spur gear are collinear.

18. The method of claim 17, wherein the coupling the face gear to the motor comprises fixedly coupling a drive spur gear of the face gear to the motor, wherein the motor rotates the drive spur gear.

19. The method of claim 14, further comprising coupling the motor to a level sensor, wherein the level sensor controls the motor.

20. The method of claim 19, further comprising instructing, by the level sensor, the motor to rotate the face gear, in response to the level sensor determining that the conveyor belt is not level.
